(19) United States
(12) Patent Application Publication
(10) Pub. No.: US 2011/0250867 A1
(43) Pub. Date: Oct. 13, 2011

(54) METHOD AND APPARATUS FOR RESTRICTING NETWORK ACCESS IN A MOBILE COMMUNICATION TERMINAL

(75) Inventor: Sung-Jun LEE, Suwon-si (KR)

(73) Assignee: SAMSUNG ELECTRONICS CO. LTD., Suwon-si (KR)

(21) Appl. No.: 13/081,937

(22) Filed: Apr. 7, 2011

(30) Foreign Application Priority Data
Apr. 7, 2010 (KR) 10-2010-0031733

(51) Int. Cl. H04W 12/08

(52) U.S. Cl. 455/411

(57) ABSTRACT

A method and an apparatus for restricting network access in a mobile communication terminal are provided. The method for restricting the network access in the mobile communication terminal includes when network access is attempted, receiving a password for a Subscriber Identification Module (SIM) card inserted into the terminal, transmitting the password to a SIM management server, receiving a password authentication result from the SIM management server, and determining whether to allow the network access according to the password authentication result.

### PRIORITY

This application claims the benefit under 35 U.S.C. §119(a) to a Korean patent application filed in the Korean Intellectual Property Office on Apr. 7, 2010, and assigned Serial No. 10-2010-0031733, the entire disclosure of which is hereby incorporated by reference.

### BACKGROUND OF THE INVENTION

1. Field of the Invention

The present invention relates generally to a method and an apparatus for restricting network access in a mobile communication terminal. More particularly, the present invention relates to a method and an apparatus for restricting network access by applying user authentication to a Subscriber Identification Module (SIM) card inserted into the mobile communication terminal.

2. Description of the Related Art

Most mobile communication terminals support a Subscriber Identification Module (SIM) card containing a user's personal information. The mobile communication terminal accesses a network based on the user information recorded in the SIM card.

The SIM card can be detached from one mobile communication terminal and inserted into another mobile communication terminal. Disadvantageously, when the SIM card is lost, the original user of the SIM card can suffer damage from malicious users. For example, when user A loses his/her SIM card or terminal including the SIM card, user B can obtain and insert the SIM card of user A into another terminal. When user B makes an international phone call or downloads data using the terminal including the SIM card of user A, user A, who is the actual owner of the SIM card, has to pay an incurred charge. Yet, user A can block the other user from accessing the network using the SIM card by requesting a network provider to suspend his/her SIM card use. However, the charges incurred until the suspension of the SIM card is requested have to be paid by user A.

In this regard, a conventional method requires a Personal Identification Number (PIN) code input to prevent the SIM card use of other users. When the mobile communication terminal is booted up, the input of the PIN code for the SIM card inserted into the mobile communication terminal is requested to the user as illustrated in FIG. 1. FIG. 1 illustrates user authentication for a SIM card in a mobile communication terminal according to the related art. The network access is allowed only when the accurate PIN code is input for the SIM card.

However, when another user, which obtains the lost mobile communication terminal that includes the SIM card, does not reboot the corresponding mobile communication terminal or when the corresponding function is not activated even after the rebooting, the PIN code input is not carried out. Therefore, when a user loses his/her SIM card, the PIN code input method still leaves damage from the malicious users.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for restricting network access in a mobile communication terminal.

Another aspect of the present invention is to provide a method and an apparatus for restricting network access by applying user authentication to a Subscriber Identification Module (SIM) card inserted into a mobile communication terminal.

Yet another aspect of the present invention is to provide a method and an apparatus for determining whether to access a network by applying user authentication to a SIM card by periods or according to a request in a mobile communication terminal.

Still another aspect of the present invention is to provide a method and an apparatus for determining whether to access a network by applying user authentication to a SIM card through a server in a mobile communication terminal.

According to an aspect of the present invention, a method for restricting network access in a mobile communication terminal is provided. The method includes, when network access is attempted, receiving a password for a SIM card inserted into the terminal, transmitting the password to a SIM management server, receiving a password authentication result from the SIM management server, and determining whether to allow the network access according to the password authentication result.

According to another aspect of the present invention, a method of a server for restricting network access of a mobile communication terminal is provided. The method includes receiving a password from a terminal to which a SIM is inserted, comparing the received password with a pre-stored password for the SIM card, and transmitting a password authentication result comprising the comparison result to the terminal.

According to yet another aspect of the present invention, an apparatus for restricting network access in a mobile communication terminal is provided. The apparatus includes a SIM card for storing user information, an input unit for, when network access is attempted, receiving a password for the SIM card, a transceiver for transmitting the password to a SIM management server and receiving a password authentication result from the SIM management server, and a controller for determining whether to allow the network access according to the password authentication result.

According to still another aspect of the present invention, an apparatus of a server for restricting network access of a mobile communication terminal is provided. The apparatus includes a receiver for receiving a password from a terminal to which a SIM is inserted, a storage for storing at least one of passwords per SIM card and user authentication periods per SIM card, a controller for retrieving a password for the SIM card in the storage and comparing the received password with the retrieved password, and a transmitter for transmitting a password authentication result comprising the comparison result to the terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates user authentication for a SIM card in a mobile communication terminal according to the related art;

FIG. 2 illustrates user authentication on a Subscriber Identification Module (SIM) card inserted into a terminal in a mobile communication system according to an exemplary embodiment of the present invention;

FIG. 3 illustrates a mobile communication terminal and a SIM management server according to an exemplary embodiment of the present invention;

FIG. 4 illustrates operations of the mobile communication terminal according to an exemplary embodiment of the present invention; and

FIG. 5 illustrates operations of a SIM management server according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

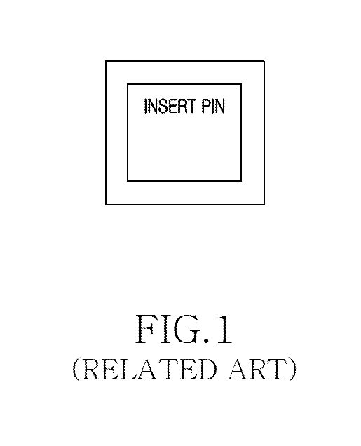

FIGS. 1 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Exemplary embodiments of the present invention provide a method and an apparatus for determining whether to access a network by applying user authentication to a Subscriber Identification Module (SIM) card through a server by periods or according to a request in a mobile communication terminal. Hereinafter, call connection of the mobile communication terminal is described by way of example. Note that the exemplary embodiments of the present invention are equally applicable to every network access attempt. The mobile communication terminal and the SIM card transmit and receive signals via a SIM Application Toolkit (SAT).

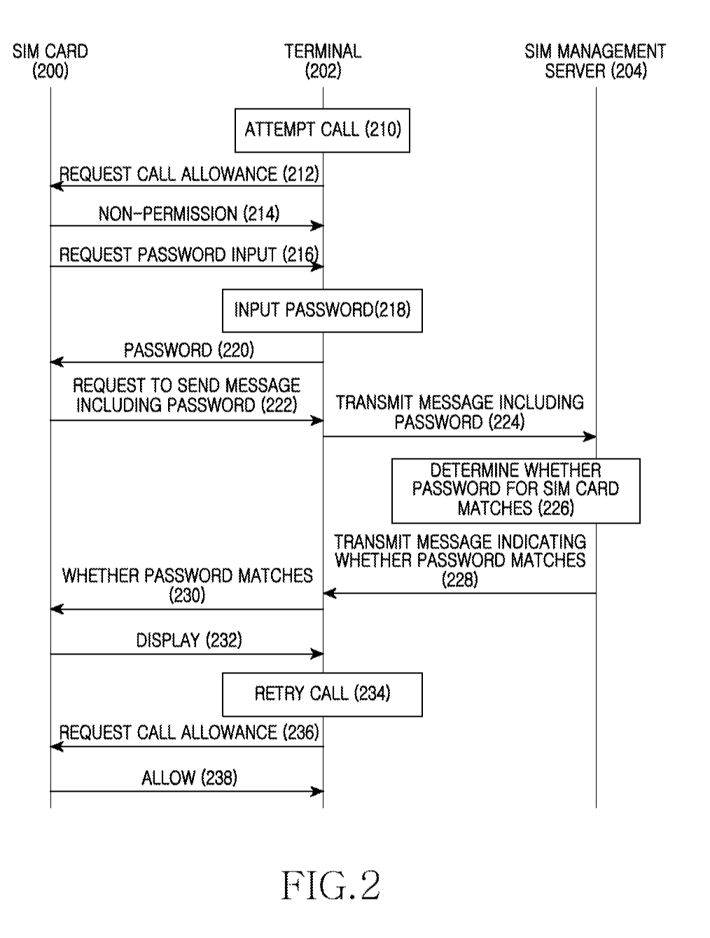

FIG. 2 illustrates user authentication on a SIM card inserted into a terminal in a mobile communication system according to an exemplary embodiment of the present invention.

Referring to FIG. 2, when a user of a terminal 202 attempts call connection to another terminal in step 210, the terminal 202 transmits a signal requesting whether the call is allowed to a SIM card 200 inserted into the terminal 202 in step 212.

Upon receiving the call allowance request, the SIM card 200 examines whether there is a user authentication result pre-stored. When detecting the pre-stored user authentication result, the SIM card 200 determines whether the corresponding user authentication result is valid. The SIM card 200 can determine whether the pre-stored user authentication result is valid, based on boot-up of the terminal 202 or a preset user authentication period. If it is determined that the pre-stored user authentication result is not valid, the SIM card 200 transmits a signal indicative of non-permission to the terminal 202 in step 214 and transmits a signal requesting to input a password for the user authentication in step 216.

The terminal 202 receives the password from the user by displaying a window requesting to input the password in a screen in step 218, and transmits the input password to the SIM card 200 in step 220.

The SIM card 200 receiving the password transmits to the terminal 202 a signal requesting to transmit a message including the password in step 222. The terminal 202 transmits a message including the password to a SIM management server 204 according to the request of the SIM card 200 in step 224. Herein, the message including the password includes identification information of the SIM card 200 so that the SIM management server 204 can identify the SIM card 200.

The SIM management server 204 determines whether the received password matches a password for the SIM card 200 in step 226. Herein, the SIM management server 204 includes a database for storing passwords per SIM card. The password of the SIM card 200 can be registered by the user when the SIM card is subscribed to the corresponding service. The SIM management server 204, with user authentication periods per SIM card, can instruct the SIM card 200 to redo the user authentication by the user authentication periods of the SIM card 200. The SIM management server 204 can instruct the SIM card 200 to redo the user authentication according to a user's request.

In step 228, the SIM management server 204 transmits to the terminal 202 a message indicating the authentication result in relation to the received password. That is, the SIM management server 204 transmits to the terminal 202 the message indicating whether the received password matches the password for the SIM card 200.

In step 230, the terminal 202 transmits to the SIM card 200 a signal indicating whether the password matches. When the password matches, the SIM card 200 records the user authentication success or failure. More specifically, upon receiving the signal indicative of the password match, the SIM card 200 records the user authentication success. When receiving the signal indicative of the password mismatch, the SIM card 200 records the user authentication failure. Herein, upon receiving the signal indicative of the password match, the SIM card 200 records the user authentication success and simultaneously stops a timer which measures the preset user authentication period. More specifically, the user authentication success is valid until the timer for measuring the user authentication period expires.

When the signal indicating the password match is input, the SIM card 200 transmits a display signal to the terminal 202 in step 232. The terminal 202 displays a window inquiring of a call connection retry in the screen in step 234. When the user selects the call connection retry, the terminal 202 transmits to the SIM card 200 a signal requesting whether the call is allowed in step 236. The SIM card 200 transmits a signal indicating the allowance to the terminal 202 in step 238 so that the terminal 202 can access the network. Herein, in step 232, the SIM card 200 can transmit the signal indicating the permission to the terminal 202 so that the terminal 202 can access the network without a separate process.

In contrast, when receiving the signal indicating the password mismatch in step 230, the SIM card 200 can transmit the signal indicating non-permission to the terminal 202 as in step 214 and repeat the subsequent operation. In so doing, the SIM card 200 determines the number of the signal inputs indicating the password mismatch. When the number of the signal inputs exceeds a preset number of times, the SIM card 200 may forbid the network access of the terminal 202.

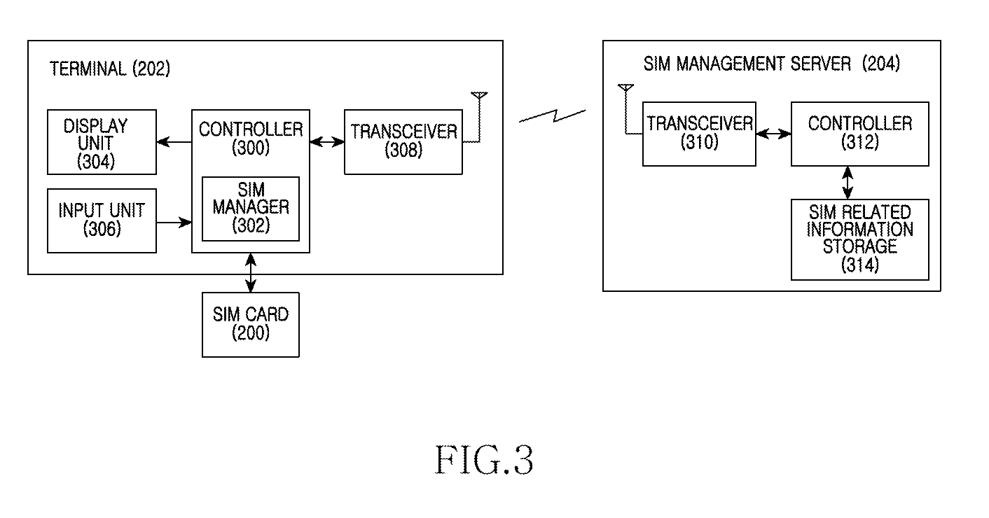

FIG. 3 illustrates a mobile communication terminal and the SIM management server according to an exemplary embodiment of the present invention.

Referring to FIG. 3, the terminal 202 includes a controller 300, a display unit 304, an input unit 306, and a transceiver 308. The SIM card 200 is inserted into the terminal 202. The SIM management server 204 includes a transceiver 310, a controller 312, and a SIM related information storage 314.

In the terminal 202, the controller 300 controls and processes operations of the terminal 202. More specifically, the controller 300 includes a SIM manager 302. In the operation requiring the network access (e.g., a call connection attempt), after the user authentication through the SIM card 200 inserted to the terminal 202, the controller 300 controls and processes to allow or forbid the network access according to the user authentication result. When the preset user authentication period of the SIM card 200 expires or when the user authentication is requested from the SIM management server 204, the controller 300 controls and processes to allow or forbid the network access through the user authentication. That is, for the user authentication, the controller 300 executes a function for receiving the password from the user and functions to transmit the message including the input password to the SIM management server 204. The controller 300 receives the password match or mismatch from the SIM management server 204, and functions to allow or forbid the network access via the SIM card 200 according to the match or mismatch.

The display unit 304 displays state information, numbers, characters, and images generating in the operations of the terminal. Under control of the controller 300, the display unit 304 can display the password input window for the SIM card 200, the user authentication success or failure, and the message indicating whether the network access is allowed.

The input unit 306 includes at least one of a keypad including at least one of a number, a character, and function keys, and a touch sensor for detecting the user's touch. The input unit 306 provides data corresponding to the key pressed by the user or coordinates of the user's touch, to the controller 300. The input unit 306 receives and forwards the password from the user to the controller 300.

The transceiver 308 transmits and receives signals over an antenna (not illustrated) under control of the controller 300. More particularly, the transceiver 308 processes signals transmitted and received to and from the SIM management server 204 under control of the controller 300.

The SIM card 200 includes a microprocessor and a memory chip therein, and stores the user's personal information. The SIM card 200 functions to authenticate the user by transmitting and receiving signals to and from the controller 300 of the terminal 202 through the SAT. When the user authentication is successful, the SIM card 200 records the user authentication success and concurrently activates the timer for measuring the user authentication period, to thus measure the valid time duration of the user authentication success. That is, when the user authentication period expires, the SIM card 200 functions to redo the user authentication because the user authentication success record is not valid any more.

In the SIM management server 402, the transceiver 310 transmits and receives signals over an antenna (not illustrated) under control of the controller 312. More particularly, the transceiver 310 processes signals transmitted and received to and from the terminal 202 under control of the controller 312.

The controller 312 controls and processes operations of the SIM management server 204. More specifically, when receiving the message including the password from the terminal 202, the controller 312 retrieves the password for the corresponding SIM card 200 in the SIM related information storage 314, determines whether the received password matches the retrieved password, and transmits the match result to the terminal 202. The controller 312 controls and processes to instruct to re-perform the user authentication to the corresponding SIM card based on the authentication period per SIM card stored to the SIM related information storage 314 by the user authentication period for the SIM card. The controller 312 can instruct each SIM card to redo the user authentication according to the user's request.

The SIM related information storage 314 includes a database for storing the passwords per SIM card. The passwords per SIM card can be registered by the user when the SIM cards are subscribed to the corresponding service. The SIM related information storage 314 contains the user authentication period per SIM card.

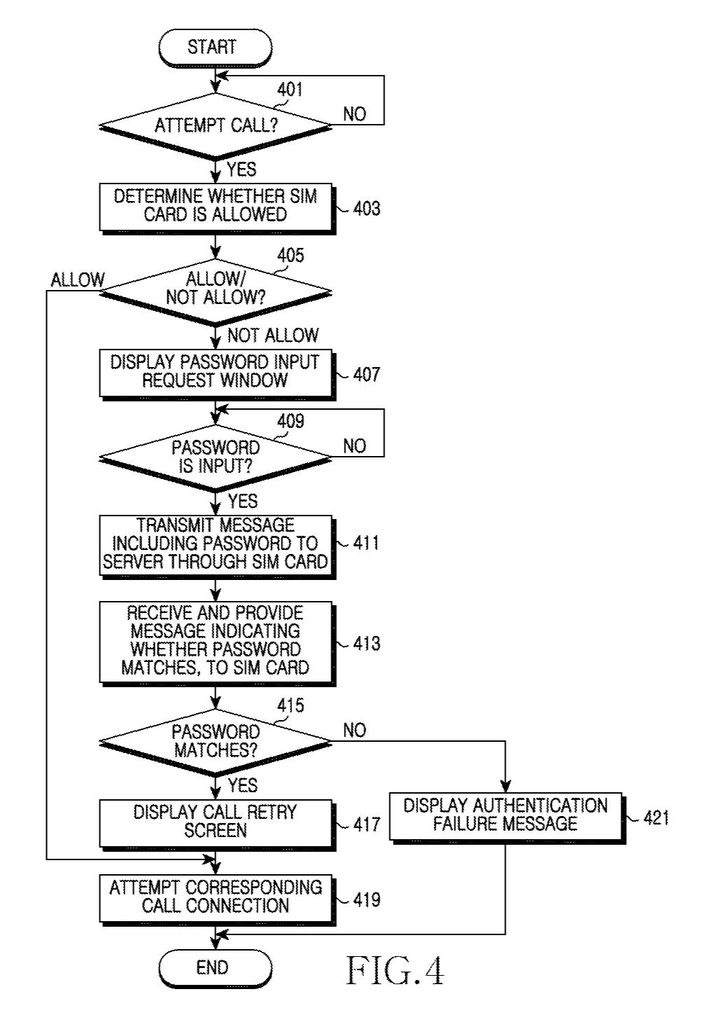

FIG. 4 illustrates operations of the mobile communication terminal according to an exemplary embodiment of the present invention.

Referring to FIG. 4, when the user attempts the call connection to another terminal in step 401, the terminal determines whether the call is allowed through the SIM card inserted into the terminal in step 403. That is, the terminal transmits the signal requesting the call permission to the SIM card and receives the signal indicating whether the call is allowed. Herein, the SIM card determines whether there is a pre-stored user authentication result. Detecting the pre-stored user authentication result, the SIM card determines whether to allow the call by determining whether the corresponding user authentication result is valid based on boot-up of the terminal or the preset user authentication period. For example, when the user authentication time expires after the user authentication result is stored or when the user authentication time does not expire but the terminal boots up, the SIM card determines that the stored user authentication result is not valid, and determines not to allow the call. In contrast, when the user authentication time does not expire after the user authentication result is stored or when the terminal does not boot up, the SIM card determines to permit the call.

Upon determining the call connection permission through the SIM card in step 405, the terminal functions to connect the call to the other terminal by accessing the network in step 419 and the process ends.

In contrast, when determining the call connection non-permission through the SIM card in step 405, the terminal displays a window requesting to input a password to the user in step 407 and then determines whether the password is input in step 409.

When the password is input, the terminal transmits the message including the password to the SIM management server through the SIM card in step 411. Herein, the message including the password includes the identification information for the SIM card, and can be a short message.

In step 413, the terminal receives the message indicating the password authentication result, that is, indicating whether the password matches, from the SIM management server and provides the message to the SIM card. In step 415, the terminal examines whether the result in the message indicates the password match.

When the result in the message indicates no password match, the terminal displays a message indicating the user authentication failure in step 421 and the process ends. Herein, when the user authentication fails over a preset number of times in succession, the terminal may block the network access.

In contrast, when the result in the message indicates the password match, the terminal displays the user authentication success in the screen and the screen indicating the call connection retry to the other terminal in step 417. The terminal functions to connect the call to the other terminal by accessing the network in step 419 and then finishes this process.

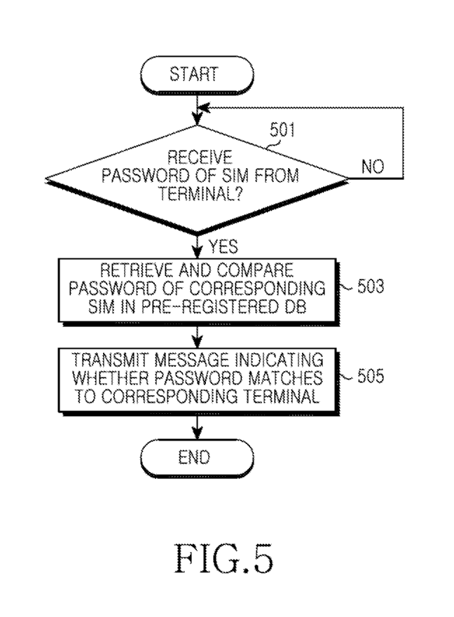

FIG. 5 illustrates operations of a SIM management server according to an exemplary embodiment of the present invention.

Referring to FIG. 5, when receiving the message including the password for the SIM card from the terminal in step 501, the SIM management server retrieves the password pre-registered for the corresponding SIM card in the database and compares the retrieved password with the password of the message in step 503.

In step 505, the SIM management server transmits the message indicating whether the password matches to the corresponding terminal. Next, the SIM management server finishes this process.

As set forth above, the mobile communication terminal determines whether to access the network by authenticating a user in relation to the SIM card through the server by regular periods or according to the request. When the SIM card is lost, it is possible to prevent other users from accessing the network with the SIM card, thus enhancing the user satisfaction level.

Although the present disclosure has been described with an exemplary embodiment, various changes and modifications may be suggested to one skilled in the art. It is intended that the present disclosure encompass such changes and modifications as fall within the scope of the appended claims.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for restricting network access in a mobile communication terminal, the method comprising:
when network access is attempted, receiving a password for a Subscriber Identification Module (SIM) card inserted into a terminal;
transmitting the password to a SIM management server;
receiving a password authentication result from the SIM management server; and
determining whether to allow the network access according to the password authentication result.

2. The method of claim 1, further comprising:
when the network access is attempted, determining whether the network access is allowed through the SIM card before the password is input.

3. The method of claim 2, wherein the determining of whether the network access is allowed through the SIM card comprises:
determining whether a pre-stored user authentication result is included in the SIM card; and
when detecting the user authentication result, determining whether the user authentication result is valid using at least one of boot-up of the terminal and a preset user authentication period.

4. The method of claim 1, wherein the determining of whether to allow the network access comprises:
when the password authentication is successful, allowing the network access; and
when the password authentication is not successful, forbidding the network access.

5. The method of claim 4, wherein the forbidding of the network access comprises:
comparing a number of consecutive failures of the password authentication with a preset number of times; and
when the number of the consecutive failures is greater than or equal to the preset number of times, forbidding the network access, and when the number of the consecutive failures is less than the preset number of times, receiving the password again.

6. The method of claim 1, wherein, when the password is transmitted to the SIM management server, identification information for the inserted SIM card is transmitted.

7. The method of claim 1, further comprising:
receiving a request for user authentication from the server; and
receiving the password and authenticating through the server according to the request.

8. A method of a server for restricting network access of a mobile communication terminal, the method comprising:
receiving a password from a terminal to which a Subscriber Identification Module (SIM) card is inserted;
comparing the received password with a pre-stored password for the SIM card; and
transmitting a password authentication result comprising the comparison result to the terminal.

9. The method of claim 8, wherein the server stores at least one of passwords per SIM card and user authentication periods per SIM card, and
the passwords per SIM card or the user authentication periods per SIM card are registered when a user of the SIM card subscribes to a corresponding service.

10. The method of claim 9, wherein the server requests user authentication to a corresponding SIM card according to the user authentication periods per SIM card.

11. An apparatus for restricting network access in a mobile communication terminal, the apparatus comprising:
a Subscriber Identification Module (SIM) card for storing user information;
an input unit for, when network access is attempted, receiving a password for the SIM card;
a transceiver for transmitting the password to a SIM management server and for receiving a password authentication result from the SIM management server; and
a controller for determining whether to allow the network access according to the password authentication result.

12. The apparatus of claim 11, wherein, when the network access is attempted, the controller determines whether the network access is allowed, through the SIM card before the password is input.

13. The apparatus of claim 12, wherein the SIM card determines whether there is a pre-stored user authentication result according to a request of the controller, and when detecting the user authentication result, determines whether the user authentication result is valid using at least one of boot-up of the terminal and a preset user authentication period.

14. The apparatus of claim 11, wherein the controller allows the network access when the password authentication is successful, and forbids the network access when the password authentication fails.

15. The apparatus of claim 14, wherein, when the password authentication fails, the controller compares a number of consecutive failures of the password authentication with a preset number of times, and controls to forbid the network access when the number of the consecutive failures is greater than or equal to the preset number of times, and to receive the password again when the number of the consecutive failures is less than the preset number of times.

16. The apparatus of claim 11, wherein, when the password is transmitted to the SIM management server, the transceiver transmits identification information for the inserted SIM card.

17. The apparatus of claim 11, wherein the receiver receives a request for user authentication from the server, and
the controller receives the password and authenticates through the server according to the request.

18. An apparatus of a server for restricting network access of a mobile communication terminal, the apparatus comprising:
a receiver for receiving a password from a terminal to which a Subscriber Identification Module (SIM) card is inserted;
a storage for storing at least one of passwords per SIM card and user authentication periods per SIM card;
a controller for retrieving a password for the SIM card in the storage and for comparing the received password with the retrieved password; and
a transmitter for transmitting a password authentication result comprising the comparison result to the terminal.

19. The apparatus of claim 18, wherein the passwords per SIM card or the user authentication periods per SIM card are registered when a user of the SIM card subscribes to a corresponding service.

20. The apparatus of claim 19, wherein the controller controls to request the user authentication to a corresponding SIM card according to the user authentication periods per SIM card.
